(19) United States
(12) Patent Application Publication
(10) Pub. No.: US 2023/0379898 A1
(43) Pub. Date: Nov. 23, 2023

(54) TERMINAL AND COMMUNICATION METHOD

(71) Applicant: NTT DOCOMO, INC., Tokyo (JP)

(72) Inventors: Shinya Kumagai, Chiyoda-ku, Tokyo (JP); Satoshi Nagata, Chiyoda-ku, Tokyo (JP); Lan Chen, Haidian District, Beijing (CN); Jing Wang, Haidian District, Beijing (CN); Qiping Pi, Haidian District, Beijing (CN)

(73) Assignee: NTT DOCOMO, INC., Tokyo (JP)

(21) Appl. No.: 18/030,672

(22) PCT Filed: Nov. 9, 2021
(86) PCT No.: PCT/JP2021/041240

§ 371 Date: Apr. 6, 2023

(30) Foreign Application Priority Data
Nov. 10, 2020 (JP) 2020-187613

(51) Int. Cl. H04W 72/11; H04W 72/0446

(52) U.S. Cl. CPC H04W 72/11; H04W 72/0446

(57) ABSTRACT

A terminal includes a receiver configured to receive data according to SPS (Semi Persistent Scheduling); a controller configured to postpone transmission of a first channel for transmitting feedback information with respect to the data until a valid uplink resource is determined, and determine a resource for transmitting the first channel in a case where the postponed first channel is overlapped in a time domain with a second channel, the second channel being another uplink channel; and a transmitter configured to transmit the feedback information to a base station in the determined resource.

### TECHNICAL FIELD

The present invention relates to a terminal and a communication method in a wireless communication system.

### BACKGROUND ART

A wireless communication system (hereinafter referred to as “NR”) called 5G or NR (New Radio) is being discussed in the 3rd Generation Partnership Project (3GPP) in order to achieve further increase of system capacity, further increase of data transmission speed, and further decrease of latency in the wireless section. In 5G, various wireless technologies and network architectures are being discussed in order to meet the requirement of achieving a throughput of 10 Gbps or higher and latency of 1 ms or less in the wireless section.

In the NR, a downlink SPS (Semi-Persistent Scheduling) is specified in which the PDSCH resource is configured in advance in the terminal and activation/release is performed by DCI, thereby allowing low-latency data reception (for example, Non-Patent Documents 1 and 2).

### RELATED ART DOCUMENTS

[Non-Patent Document 1] 3GPP TS 38. 213 V16. 3. 0 (2020-09)
[Non-Patent Document 2] 3GPP TS 38. 331 V16. 2. 0 (2020-09)

### SUMMARY OF THE INVENTION

### Problem to be Solved by the Invention

In a case where a UL slot is located after consecutive multiple DL slots, the terminal may transmit multiple HARQ-ACKs corresponding to multiple data reception in the UL slot after the DL slots, and the reliability of HARQ-ACK may be decreased in a case where the load of HARQ-ACK payload (the density of information contained in the payload) is high.

Also, in the case of postponing transmission of a HARQ-ACK, the next available PUCCH resource may be selected autonomously by the terminal without an indication from the base station, and thus, a collision may occur between transmission of the postponed HARQ-ACK by one terminal and transmission of the postponed HARQ-ACK by another terminal.

In order to avoid a collision between sending a postponed HARQ-ACK by one terminal and sending a postponed HARQ-ACK by another terminal, when using UL cancellation indication (CI), sending a postponed HARQ-ACK is dropped rather than further postponed. That is, it is not assumed to use UL CI to avoid collisions between sending a postponed HARQ-ACK by one terminal and sending a postponed HARQ-ACK by another terminal.

The present invention has been made in view of the foregoing, and is intended to enable the terminal that has received data to appropriately transmit feedback information for data reception to the base station.

### Means for Solving the Problem

According to the disclosed technique, a terminal includes: a receiver configured to receive data according to SPS (Semi Persistent Scheduling); a controller configured to postpone transmission of a first channel for transmitting feedback information with respect to the data until a valid uplink resource is determined, and determine a resource for transmitting the first channel in a case where the postponed first channel is overlapped in a time domain with a second channel, the second channel being another uplink channel; and a transmitter configured to transmit the feedback information to a base station in the determined resource.

### Advantageous Effect of the Present Invention

According to the disclosed technique, a technique is provided which allows the terminal receiving the data to appropriately transmit feedback information to the base station.

### BRIEF DESCRIPTION OF THE DRAWINGS

FIG. 1 is a diagram illustrating a wireless communication system according to an embodiment of the present invention;

FIG. 2 is a diagram illustrating a wireless communication system according to an embodiment of the present invention;

FIG. 3 is a sequence diagram illustrating a basic operation of a wireless communication system according to an embodiment of the present invention;

FIG. 4 is a diagram illustrating an example of SPS HARQ-ACK;

FIG. 5 is a diagram illustrating an example (1) where SPS HARQ-ACK collides with other UL channels;

FIG. 6 is a diagram illustrating an example (2) where SPS HARQ-ACK collides with other UL channels;

FIG. 7 is a flowchart illustrating an example (1) of the SPS HARQ-ACK transmission according to an embodiment of the present invention;

FIG. 8 is a flowchart illustrating an example (2) of the SPS HARQ-ACK transmission according to an embodiment of the present invention;

FIG. 9 is a flowchart illustrating an example (3) of the SPS HARQ-ACK transmission according to an embodiment of the present invention;

FIG. 10 is a flowchart illustrating an example (4) of the SPS HARQ-ACK transmission according to an embodiment of the present invention;

FIG. 11 is a flowchart illustrating an example (5) of the SPS HARQ-ACK transmission according to an embodiment of the present invention;

FIG. 12 is a flowchart illustrating an example (6) of the SPS HARQ-ACK transmission according to an embodiment of the present invention;

FIG. 13 is a flowchart illustrating an example (7) of the SPS HARQ-ACK transmission according to an embodiment of the present invention;

FIG. 14 is a diagram illustrating an example of a functional configuration of the base station 10 according to an embodiment of the present invention;

FIG. 15 is a diagram illustrating an example of a functional configuration of a terminal 20 according to an embodiment of the present invention; and

FIG. 16 is a diagram illustrating an example of a hardware configuration of the base station 10 or the terminal 20 according to an embodiment of the present invention.

### EMBODIMENTS FOR CARRYING OUT THE INVENTION

Hereinafter, embodiments of the present invention will be described with reference to the drawings. The embodiments described below are examples, and the embodiments to which the present invention is applied are not limited to the following embodiments.

In operating a wireless communication system according to an embodiment of the present invention, existing techniques may be used as appropriate. The existing technology is, for example, an existing NR or LTE, but is not limited to an existing NR or LTE.

(System Configuration)

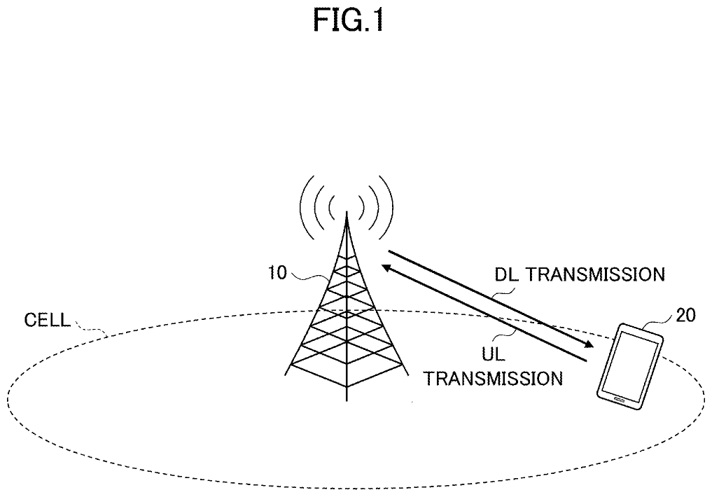

FIG. 1 is a diagram illustrating a wireless communication system according to an embodiment of the present invention. The wireless communication system in an embodiment of the present invention includes a base station 10 and a terminal 20, as illustrated in FIG. 1. In FIG. 1, one base station 10 and one terminal 20 are illustrated, but this is an example and may be more than one each.

The base station 10 is a communication device that provides one or more cells and performs wireless communication with the terminal 20. The physical resources of the radio signal are defined in the time domain and the frequency domain, the time domain may be defined in OFDM symbols, and the frequency domain may be defined in sub-carriers or resource blocks. The TTI (Transmission Time Interval) in the time domain may be a slot, or the TTI may be a subframe.

The base station 10 can perform carrier aggregation to communicate with terminal 20 by bundling a plurality of cells (CC (component carriers)). Carrier aggregation uses one PCell (primary cell) and one or more SCells (secondary cells).

The base station 10 transmits synchronization signals and system information to the terminal 20. The synchronization signals are, for example, NR-PSS and NR-SSS. System information is transmitted, for example, by NR-PBCH or PDSCH, and is also called broadcast information. As illustrated in FIG. 1, the base station 10 transmits the control signal or data in DL (Downlink) to the terminal 20 and receives the control signal or data in UL (Uplink) from the terminal 20. Here, what is transmitted by a control channel such as PUCCH and PDCCH is called a control signal, and what is transmitted by a shared channel such as PUSCH and PDSCH is called data. These names are examples.

The terminal 20 is a communication device with a wireless communication function, such as a smartphone, cellular phone, tablet, wearable terminal, and a communication module for M2M (Machine-to-Machine). As illustrated in FIG. 1, the terminal 20 utilizes various communication services provided by a wireless communication system by receiving control signals or data at DL from the base station 10 and transmitting control signals or data at UL to the base station 10. The terminal 20 may be referred to as a UE, and the base station 10 may be referred to as a gNB.

The terminal 20 can perform carrier aggregation to communicate with base station 10 by bundling a plurality of cells (a plurality of CC (component carriers)). Carrier aggregation uses one PCell (primary cell) and one or more SCells (secondary cells). PUCCH-SCell having PUCCH may also be used.

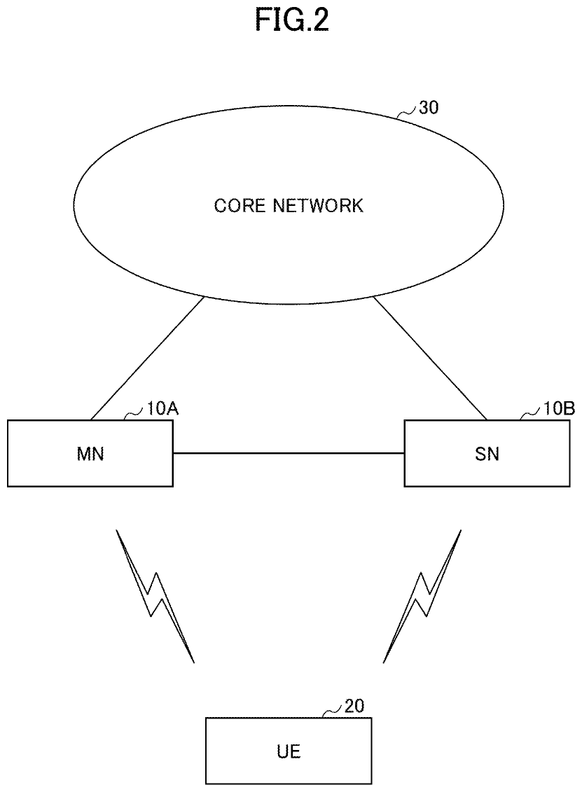

FIG. 2 illustrates an example of a configuration of a wireless communication system when DC (Dual connectivity) is executed. As illustrated in FIG. 2, a base station 10A serving as a MN (Master Node) and a base station 10B serving as a SN (Secondary Node) are provided. The base station 10A and base station 10B are each connected to a core network. The terminal 20 may communicate with both base station 10A and base station 10B.

The cell group provided by the base station 10A that is a MN is called MCG (Master Cell Group), and the cell group provided by the base station 10B that is a SN is called SCG (Secondary Cell Group). In addition, in DC, the MCG includes one PCell and one or more SCells, and the SCG includes one PSCell (Primary SCell) and one or more SCells.

The processing operation according to this embodiment may be performed in the system configuration illustrated in FIG. 1, in the system configuration illustrated in FIG. 2, or may be performed in other system configurations.

### Basic Operation Example

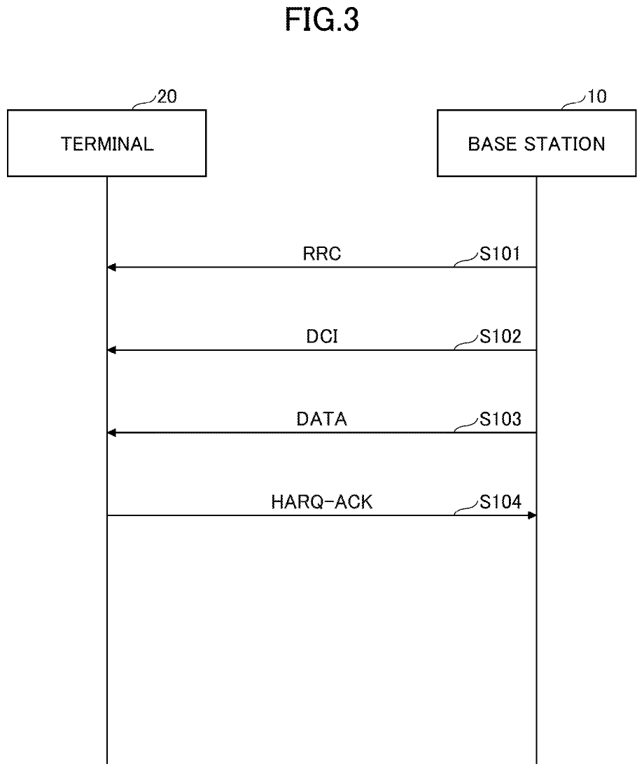

Referring to FIG. 3, a basic operation example of a communication system according to an embodiment of the present invention will be described. This operation is essentially common to the first to tenth embodiments which will be described later.

In S101, through RRC signaling, the base station 10 transmits the configuration information of the downlink SPS, the configuration information of the PUCCH resource, the configuration information of the slot format, and the like to the terminal 20, and the terminal 20 receives the configuration information. Because this embodiment is directed to the downlink SPS, the term “SPS” hereinafter means the downlink SPS.

The configuration information of the slot format is, for example, tdd-UL-DL-ConfigurationCommon or tdd-UL-DL-ConfigurationDedicated, and the configuration information configures whether the TDD configuration of each symbol of each slot in one or more slots is DL, UL, or flexible. This configuration information is called semi-static TDD configuration information. Flexible information may be referred to as “F”. The terminal 20 basically determines the DL/UL/F of each symbol of each slot according to the semi-static TDD configuration information.

As the configuration information in S101, a plurality of candidates of the slot format may be indicated in order to enable dynamic switching of the slot format. This configuration information is, for example, SlotFormatCombinationsPerCell. This information includes the ID of the slot format (SF) and is hereinafter referred to as SFI configuration information.

In S102, the terminal 20 receives the DCI activating the SPS configuration from the base station 10, and in S103, the data is received via the PDSCH resource according to the SPS configuration. In S104, the terminal 20 transmits the SPS HARQ-ACK to the base station 10 via the PUCCH resource (or PUSCH resource if UL scheduling is present) in slots at time positions specified by the DCI. Note that SPS HARQ-ACK is sometimes called HARQ-ACK. The HARQ-ACK may also be referred to as HARQ information, feedback information, etc.

The terminal 20 may also receive the DCI that dynamically specifies a slot format from the base station 10 at, before, or after, S102. This DCI is control information that specifies the ID to be actually used out of the IDs of multiple slot formats configured in the SFI configuration information. In a case where the slot format is specified by this DCI, the terminal 20 determines the DL/UL/F of each symbol of each slot according to the slot format instead of the semi-static TDD configuration information. This DCI information is called dynamic SFI specification information (or dynamic SFI or SFI).

(Problems)

As described above, each time data is received according to the SPS, the time position (slot), at which the HARQ-ACK is transmitted via the PUCCH resource, is specified to the terminal 20 by the activation DCI.

However, particularly, in a case where a plurality of short-period SPSs are configured to the terminal 20, depending on the TDD DL/UL configuration (configuration by the semi-static TDD configuration information or the dynamic SFI specification information) in the slot of the specified time position, the symbol position, at which the PUCCH resource is configured, may collide with the DL symbol or the F symbol, and thus, the HARQ-ACK cannot be transmitted.

In a case where a PUCCH resource collides with a DL or F symbol, HARQ-ACK can be dropped, but the dropping of HARQ-ACK requires PDSCH retransmission. Accordingly, the dropping of HARQ-ACK is undesirable because of the increased delay.

### BACKGROUND

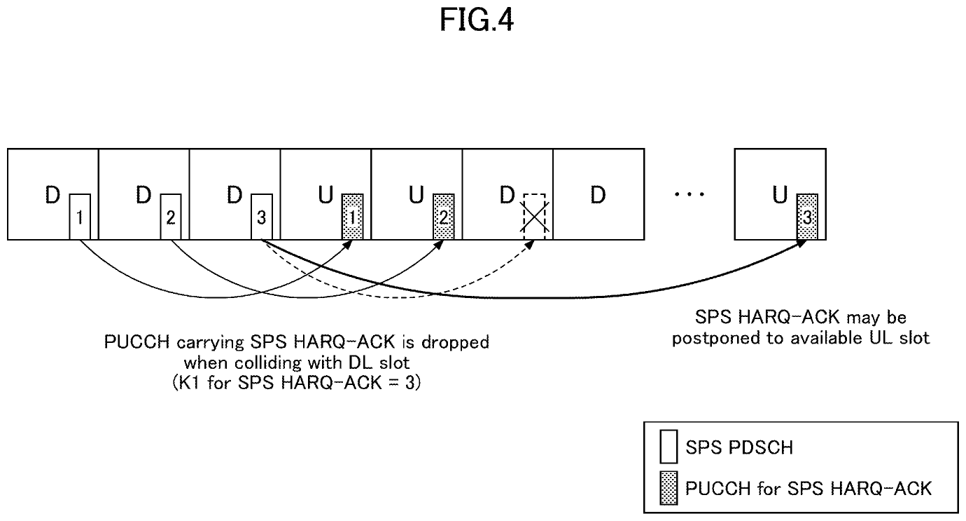

FIG. 4 illustrates an example of a collision as described above. In the example of FIG. 4, the third slot from the slot immediately following the slot in which the PDSCH is received, is specified as a slot for HARQ-ACK transmission, but in a case where the slot corresponds to DL, the HARQ-ACK is dropped.

In this embodiment, dropping of HARQ-ACK due to collisions between the PUCCH resource and DL/F symbols can be avoided.

Specifically, for example, as illustrated in FIG. 4, in a case where a collision between the PUCCH resource and the DL symbol/F symbol is determined to occur, the terminal 20 postpones the transmission to the next available UL resource, and then transmits the HARQ-ACK.

At the 3GPP meeting, an enhancement of R.17 is agreed to be performed in order to avoid dropping of the SPS HARQ-ACK due to the PUCCH colliding with at least one “DL or F symbol” in TDD.

As an enhancement method for avoiding the dropping of the SPS HARQ-ACK due to the PUCCH colliding with at least one “DL or F symbol”, the terminal 20 postpones the HARQ-ACK to the first available valid PUCCH resource.

When postponing the SPS HARQ-ACK transmission, it is important to determine which PUCCH resource is to be used for transmitting the SPS HARQ-ACK. In a case where the PUCCH resource determined for transmitting the SPS HARQ-ACK does not overlap or is multiplexed in the time domain with other UL channels (e.g., PUCCH or PUSCH), the K1 value indicating the offset from the data to the corresponding HARQ-ACK may be increased to a slot or sub-slot where the valid PUCCH resource is located. It should be noted that there may be other limitations with respect to the postponement, such as the maximum value limit of K1 value and whether the postponed resource is applicable or not.

On the other hand, in a case where the PUCCH resource determined for transmitting the postponed SPS HARQ-ACK overlaps or is multiplexed in the time domain with other UL channels (e.g., PUCCH or PUSCH), the result of determining which slot or sub-slot is to be used for transmission of the postponed SPS HARQ-ACK, may affect the UL multiplexing operation.

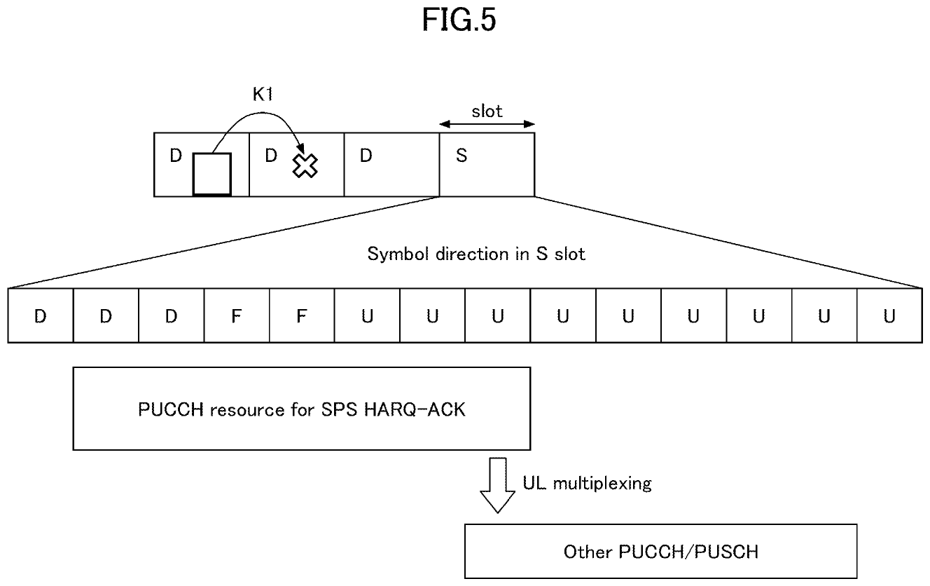

FIG. 5 illustrates an example (1) where SPS HARQ-ACK collides with other UL channels. “D” illustrated in FIG. 5 corresponds to a DL symbol, “F” corresponds to a flexible symbol, and “U” corresponds to a UL symbol. As illustrated in FIG. 5, the PUCCH resource for transmitting the SPS HARQ-ACK collides with an invalid symbol (e.g., D or F symbols). On the other hand, other UL channels that are subject to UL multiplexing do not collide with an invalid symbol.

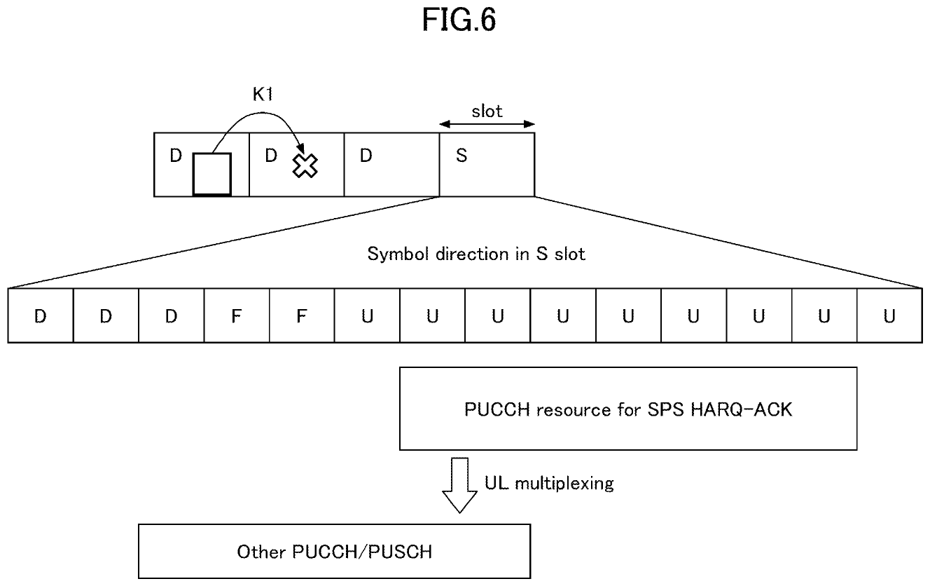

FIG. 6 illustrates an example (2) where SPS HARQ-ACK collides with other UL channels. As illustrated in FIG. 6, the PUCCH resource for transmitting the SPS HARQ-ACK does not collide with an invalid symbol. On the other hand, other UL channels that are subject to UL multiplexing collide with an invalid symbol.

As illustrated in FIG. 5 or 6, where PUCCH transmitting the postponed SPS HARQ-ACK overlaps other UL channels, for example, the execution order of two processes related to multiplexing and TDD configuration, affects operations.

### Embodiments

Thus, the method described below may be applied with respect to the determination of the PUCCH resource for transmitting the postponed SPS HARQ-ACK that may collide with other UL channels in a slot or sub-slot. Hereinafter, the term “overlapping” may be replaced by the term “to be multiplexed.”

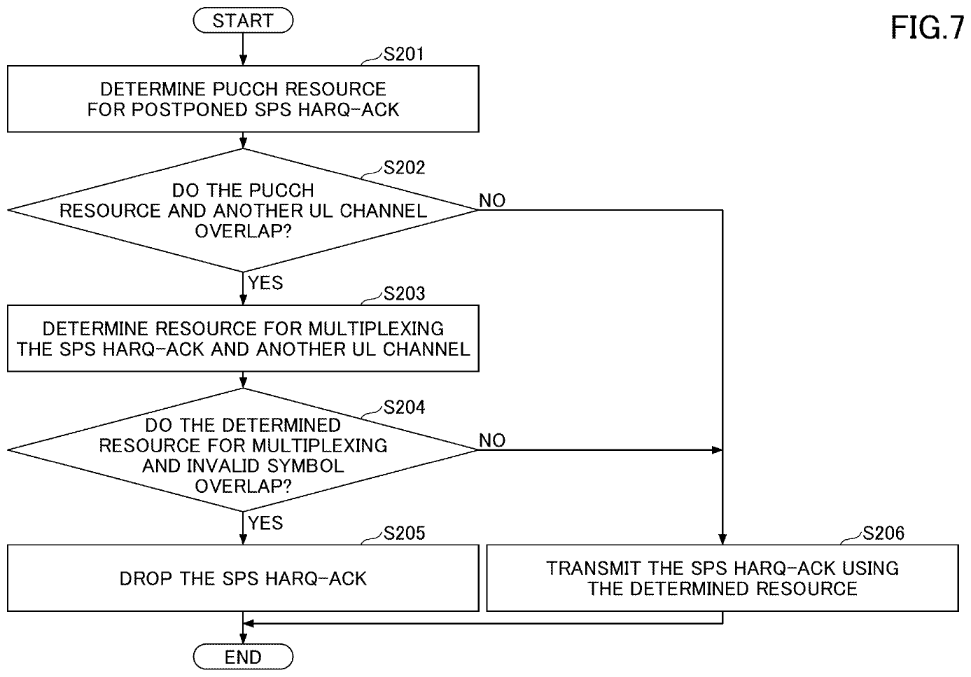

FIG. 7 is a flowchart illustrating an example (1) of SPS HARQ-ACK transmission in an embodiment of the present invention. In step S201, the terminal 20 determines the PUCCH resource for the postponed SPS HARQ-ACK. Subsequently, the terminal 20 determines whether the PUCCH resource and other UL channels overlap (S202). In a case where there is an overlap (YES in S202), the process proceeds to step S203, and in a case where there is no overlap (NO in S202), the process proceeds to step S206.

In step S203, the terminal 20 determines a resource used for multiplexing the SPS HARQ-ACK and other UL channels and proceeds to step S204. Subsequently, the terminal 20 determines whether the determined resource to be multiplexed and an invalid symbol overlap (S204). In a case where there is an overlap (YES in S204), the process proceeds to step S205, and in a case where there is no overlap (NO in 3204), the process proceeds to step 3206.

In step S205, the terminal 20 drops the SPS HARQ-ACK. On the other hand, in step S206, the terminal 20 transmits the SPS HARQ-ACK using the determined resource.

As described above, the process related to multiplexing may be executed first, and the process related to checking of the TDD configuration may be executed second. Further, whether SPS HARQ-ACK can be postponed may be determined, depending on whether the resource for multiplexing the SPS HARQ-ACK and other UL channels collides with an invalid symbol.

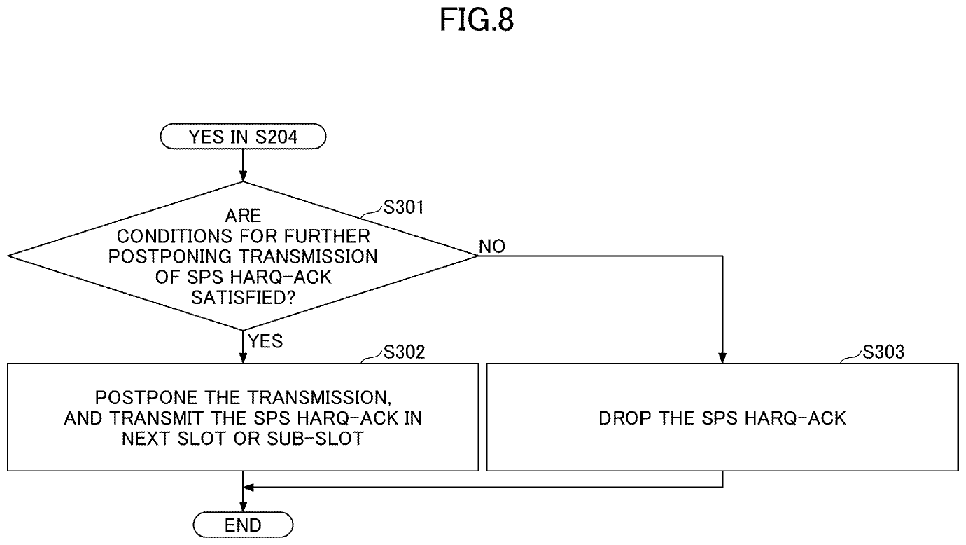

FIG. 8 is a flowchart illustrating an example (2) of SPS HARQ-ACK transmission in an embodiment of the present invention. Another example starting from the YES of step S204 illustrated in FIG. 7 is illustrated using FIG. 8. In step S301, the terminal 20 determines whether the conditions for further postponing the transmission of the SPS HARQ-ACK are satisfied. Such further postponing conditions may be one of or a plurality of 1) to 4) illustrated below.
1) Maximum value of K1
2) Collision with a semi-static DL symbol according to TDD
3) Collision with a semi-static flexible symbol according to TDD
4) Other conditions required for postponement

In a case where the conditions for further postponing the transmission of the SPS HARQ-ACK are satisfied (YES of S301), the process proceeds to step S302, and in a case where the conditions for further postponing the transmission of the SPS HARQ-ACK are not satisfied (NO of S301), the process proceeds to step S303. In step S302, the terminal 20 postpones the transmission, and then transmits the SPS HARQ-ACK in the next slot or sub-slot. On the other hand, in step S303, the terminal 20 drops the SPS HARQ-ACK.

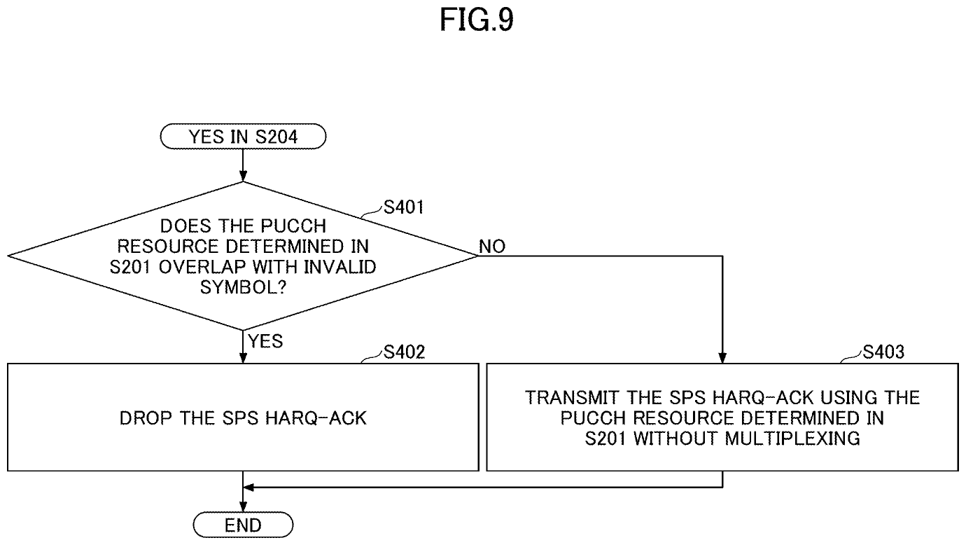

FIG. 9 is a flowchart illustrating an example (3) of SPS HARQ-ACK transmission in an embodiment of the present invention. FIG. 9 illustrates another example starting from the YES of step S204 illustrated in FIG. 7. In step S401, the terminal 20 determines whether the PUCCH resource determined in step S201 overlaps with an invalid symbol. In a case where there is an overlap (YES of S401), the process proceeds to step S402, and in a case where there is no overlap (NO of S401), the process proceeds to step S403. In step S402, the terminal 20 drops the SPS HARQ-ACK. On the other hand, in step S403, the terminal 20 transmits the SPS HARQ-ACK via the PUCCH resource determined in 3201 without multiplexing.

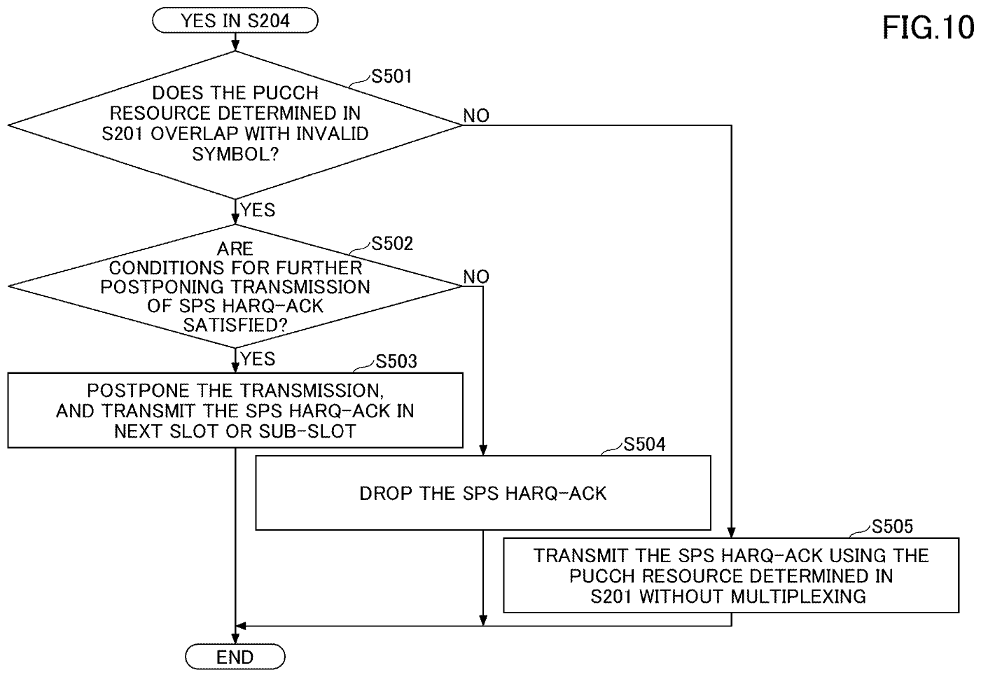

FIG. 10 is a flowchart illustrating an example (4) of SPS HARQ-ACK transmission in an embodiment of the present invention. FIG. 10 illustrates another example starting from the YES of step S204 illustrated in FIG. 7. In step 3501, the terminal 20 determines whether the PUCCH resource determined in step S201 overlaps with an invalid symbol. In a case where there is an overlap, (YES in 3501), the process proceeds to step 3402, and in a case where there is no overlap, (NO in S501), the process proceeds to step S503. In step S502, the terminal 20 determines whether the conditions for further postponing the transmission of the SPS HARQ-ACK are satisfied. In a case where the conditions for further postponing the transmission of the SPS HARQ-ACK are satisfied (YES of S502), the process proceeds to step S503, and in a case where the conditions for further postponing the transmission of the SPS HARQ-ACK are not satisfied (NO of S502), the process proceeds to step S504. In step S503, the terminal 20 postpones the transmission, and then transmits the SPS HARQ-ACK in the next slot or sub-slot. On the other hand, in step S504, the terminal 20 drops the SPS HARQ-ACK. In step S505, the terminal 20 transmits the SPS HARQ-ACK via the PUCCH resource determined in S201 without multiplexing.

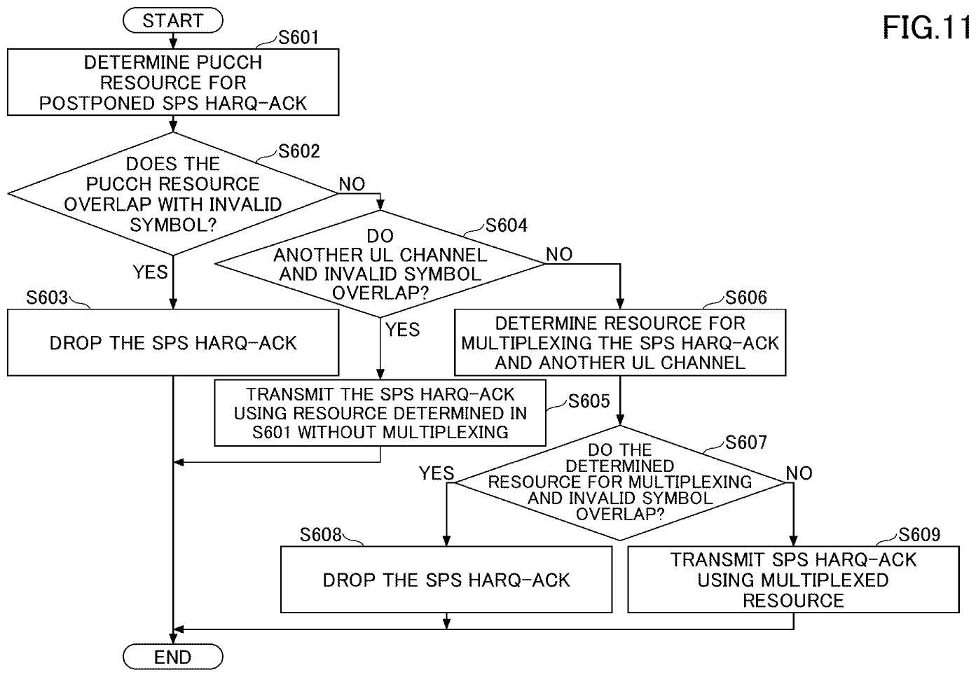

FIG. 11 is a flowchart illustrating an example (5) of SPS HARQ-ACK transmission in an embodiment of the present invention. In step S601, the terminal 20 determines the PUCCH resource for the postponed SPS HARQ-ACK. Subsequently, the terminal 20 determines whether the PUCCH resource overlaps with an invalid symbol (S602). In a case where there is an overlap (YES of S602), the process proceeds to step S603, and in a case where there is no overlap (NO of S602), the process proceeds to step 3604.

In step S603, the terminal 20 drops the SPS HARQ-ACK. On the other hand, in step S604, the terminal 20 determines whether the other UL channels and an invalid symbol overlap. In a case where there is an overlap (YES of S604), the process proceeds to step S605, and in a case where there is no overlap (NO of S604), the process proceeds to step S606. In step S605, the terminal 20 transmits the SPS HARQ-ACK via the PUCCH resource determined in S201 without multiplexing.

On the other hand, in step 3606, the terminal 20 determines a resource for multiplexing the SPS HARQ-ACK and other UL channels and proceeds to step S607. Subsequently, the terminal 20 determines whether the determined resource to be multiplexed and an invalid symbol overlap (S607). In a case where there is an overlap (YES of 3607), the process proceeds to step S608, and in a case where there is no overlap (NO of 3607), the process proceeds to step S609.

In step S608, the terminal 20 drops the SPS HARQ-ACK. On the other hand, in step S609, the terminal 20 transmits the SPS HARQ-ACK using the determined resource.

As described above, the process related to checking of the TDD configuration may be performed first, and the process related to the multiplexing may be performed second. Whether the SPS HARQ-ACK can be postponed, may be determined depending on whether the resource for the postponed SPS HARQ-ACK collides with an invalid symbol.

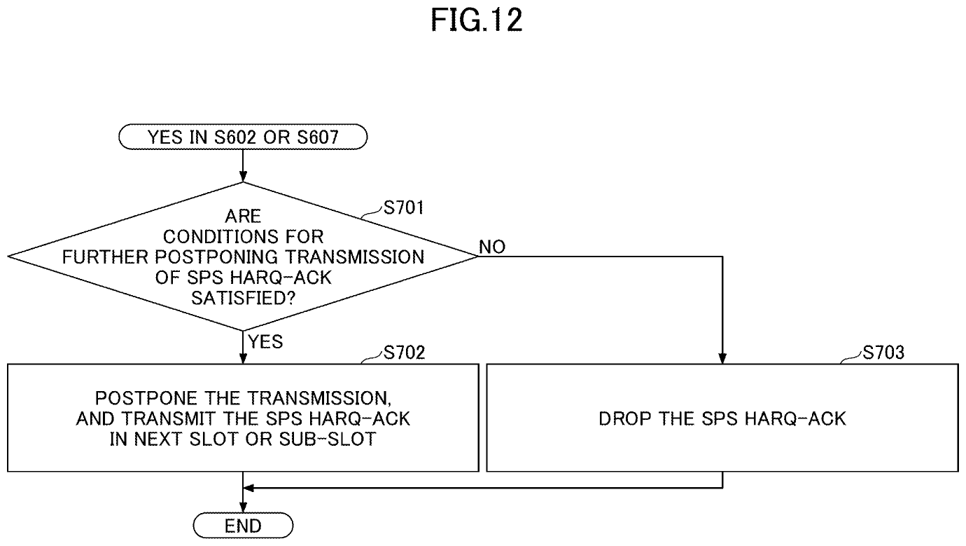

FIG. 12 is a flowchart illustrating an example (6) of SPS HARQ-ACK transmission in an embodiment of the present invention. Using FIG. 12, another example starting from the YES of step S602 or S607 illustrated in FIG. 11 is illustrated.

In step S701, the terminal 20 determines whether the conditions for further postponing the transmission of the SPS HARQ-ACK are satisfied. In a case where the conditions for further postponing the transmission are satisfied (YES of S701), the process proceeds to step 3702, and in a case where the conditions for further postponing the transmission are not satisfied (NO of S701), the process proceeds to step S703. In step 702, the terminal 20 postpones the transmission, and then transmits the SPS HARQ-ACK in the next slot or sub-slot. On the other hand, in step S703, the terminal 20 drops the SPS HARQ-ACK.

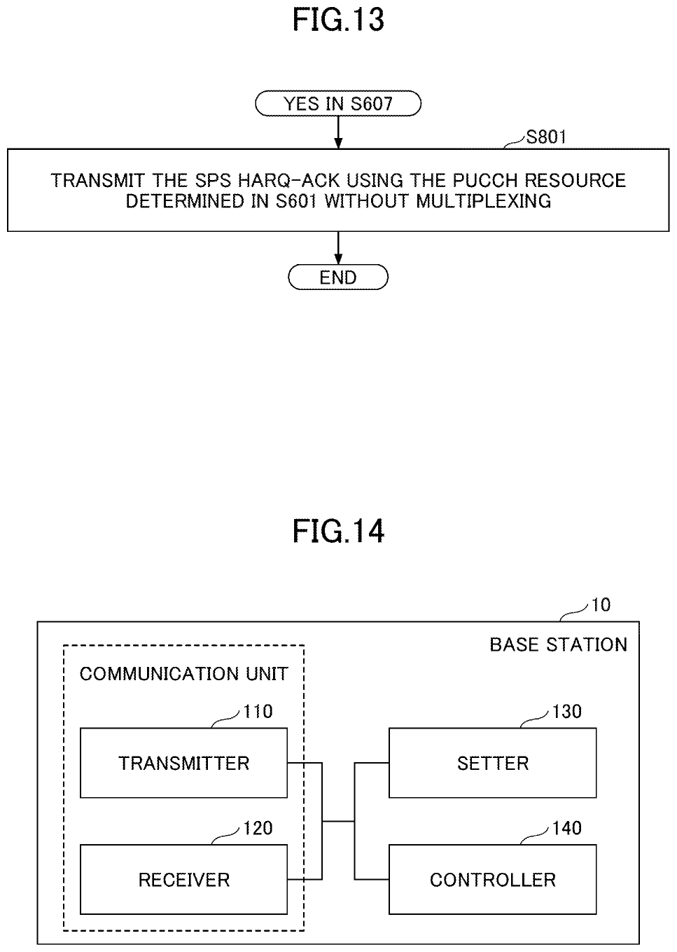

FIG. 13 is a flowchart illustrating an example (7) of SPS HARQ-ACK transmission in an embodiment of the present invention. FIG. 13 illustrates another example starting from YES of step S607 illustrated in FIG. 11. In step S801, the terminal 20 transmits the SPS HARQ-ACK via the PUCCH resource determined in S601 without multiplexing.

Here, cases A) to C) illustrated below are assumed to be the cases where the postponed SPS HARQ-ACK is to be multiplexed.
A) A case where the postponed SPS HARQ-ACK is multiplexed with one or more HARQ-ACKs, which are associated with DCI and to which the same codebook type (CB type) is applied
B) A case where PUCCH for transmitting the postponed SPS HARQ-ACK overlaps with PUCCH carrying P-CSI (Periodic CSI)/SP-CSI (Semi-persistent CSI)
C) A case where PUCCH for transmitting the postponed SPS HARQ-ACK overlaps with DG (Dynamic grant)/CG (Configured grant)

Note that, in a case where other conditions exist for the SPS HARQ-ACK except for the collision due to the TDD configuration, all of the other conditions are assumed to be satisfied in the embodiment of the present invention. It is also assumed that all the processing time required for multiplexing is satisfied in embodiments of the present invention.

The condition for further postponing the SPS HARQ-ACK transmission may be one or more of 1) to 4) illustrated below.
1) Maximum value of K1
2) Collision with a semi-static DL symbol according to TDD
3) Collision with a semi-static flexible symbol according to TDD
4) Other conditions required for postponement

Note that the candidate PUCCH resources for determining the PUCCH resource in the slot or sub-slot where the postponed SPS HARQ-ACK is transmitted, may be a PUCCH resource for transmitting the SPS HARQ-ACK alone, or may be a PUCCH resource that includes a dynamic HARQ-ACK or other configured PUCCH resources.

The above-described case A) where the postponed SPS HARQ-ACK is multiplexed with one or more HARQ-ACKs, which are associated with DCI and to which the same codebook type is applied, will be described below.

In the current specification, according to the HARQ-ACK CB generation procedure, all HARQ-ACK bits using the same CB type are included in one HARQ-ACK CB and are transmitted via a PUCCH resource configured for the HARQ-ACK associated with the DCI. The PUCCH resource is not expected to collide with an invalid symbol.

In the method of postponing the SPS HARQ-ACK described in FIGS. 7 through 10 (hereinafter referred to as “Option 1”), the terminal 20 may transmit the postponed SPS HARQ-ACK as a dynamic HARQ-ACK bit in a PUCCH resource for transmitting the dynamic HARQ-ACK.

In the method of postponing the SPS HARQ-ACK described in FIGS. 11 through 13 (hereinafter referred to as “Option 2”), the terminal 20 may determine the PUCCH resource for transmitting the postponed SPS HARQ-ACK in the targeted slot or sub-slot in which the SPS HARQ-ACK bit is transmitted.

In a case where the determined PUCCH resource does not collide with an invalid symbol, multiplexing may be applied. The terminal 20 may transmit the postponed SPS HARQ-ACK as a dynamic HARQ-ACK bit in the PUCCH resource for the dynamic HARQ-ACK.

In a case where the determined PUCCH resource collides with an invalid symbol, the SPS HARQ-ACK may be dropped. Also, in a case where the determined PUCCH resource collides with an invalid symbol, the terminal 20 may postpone the SPS HARQ-ACK transmission in a case where conditions for further postponing the transmission are satisfied, or may drop the SPS HARQ-ACK in a case where the conditions for further postponing the transmission are not satisfied.

The above-described case B) where PUCCH for transmitting the postponed SPS HARQ-ACK overlaps with PUCCH carrying P-CSI (Periodic CSI)/SP-CSI (Semi-persistent CSI), will be described below.

In the current specification, in a case where the postponed SPS HARQ-ACK is transmitted in the same slot or sub-slot as the HARQ-ACK associated with the DCI, the HARQ-ACK may be transmitted in a dynamic HARQ-ACK resource, and multiplexing may be performed based on a case where the dynamic HARQ-ACK resource and the CSI PUCCH resource overlap. In a case where the SPS HARQ-ACK alone is located in the slot or sub-slot, a case of multiplexing with the PUCCH of the P-CSI/SP-CSI is required to be considered.

In Option 1, in a case where the CSI resource to be multiplexed does not collide with an invalid symbol, the SPS HARQ-ACK can be postponed to the slot or sub-slot in which the CSI resource is located, and the postponed SPS HARQ-ACK may be multiplexed with the P-CSI/SP-CSI, and then may be transmitted via the CSI resource.

In Option 1, in a case where the CSI resource to be multiplexed collides with an invalid symbol (a collision may occur because there is no DCI with which SP-CSI/A-CSI (Aperiodic CSI) is associated), the terminal 20 may drop the SPS HARQ-ACK. Also, in Option 2, in a case where the CSI resource to be multiplexed collides with an invalid symbol, the terminal 20 may postpone transmission of the SPS HARQ-ACK to the next slot or sub-slot in a case where the conditions for further postponement are satisfied, and may drop the SPS HARQ-ACK in a case where the conditions are not satisfied.

Also, in Option 1, in a case where the CSI resource to be multiplexed collides with an invalid symbol, the terminal 20 may check whether the PUCCH resource for the postponed SPS HARQ-ACK before multiplexing collides with an invalid symbol. In a case where there is no collision, the terminal 20 may transmit the SPS HARQ-ACK via the PUCCH resource for the postponed SPS HARQ-ACK before multiplexing; in a case where there is a collision, the terminal 20 may drop the SPS HARQ-ACK, and in a case where the conditions for further postponement are satisfied, the SPS HARQ-ACK transmission may be postponed to the next slot or sub-slot, and in a case where the conditions are not satisfied, the SPS HARQ-ACK may be dropped.

In Option 2, in a case where the PUCCH resource for the postponed SPS HARQ-ACK does not collide with an invalid symbol, the terminal 20 may perform the operations illustrated in 1) or 2) below.
1) In a case where the P-CSI/SP-CSI resource collides with an invalid symbol, multiplexing with CSI is not required to be performed, and the postponed SPS HARQ-ACK may be transmitted in a slot or sub-slot where the P-CSI/SP-CSI resource is located.
2) In a case where the P-CSI/SP-CSI resource does not collide with an invalid symbol, a resource to be multiplexed may be determined. In a case where the resource to be multiplexed does not collide with an invalid symbol, then the multiplexing may be applied and the SPS HARQ-ACK may be multiplexed to be transmitted in the resource to be multiplexed. In a case where the resource to be multiplexed collides with an invalid symbol, the channel to be multiplexed is not required to be transmitted, and the terminal 20 may drop the SPS HARQ-ACK, and in a case where the conditions for further postponement are satisfied, the SPS HARQ-ACK transmission may be postponed to the next slot or sub-slot, and in a case where the conditions are not satisfied, the SPS HARQ-ACK may be dropped. The terminal 20 may also transmit the SPS HARQ-ACK via the PUCCH resource for the postponed SPS HARQ-ACK before multiplexing in a case where the resource to be multiplexed collides with an invalid symbol.

In Option 2, in a case where the PUCCH resource for the postponed SPS HARQ-ACK collides with an invalid symbol, the terminal 20 may drop the SPS HARQ-ACK and, in a case where the conditions for further postponement are satisfied, the transmission of the SPS HARQ-ACK may be postponed to the next slot or subslot, and, in a case where such conditions are not satisfied, the SPS HARQ-ACK may be dropped.
C) The case where PUCCH for transmitting the postponed SPS HARQ-ACK overlaps with DG (Dynamic grant)/CG (Configured grant) is described below.

In the current specification, in a case where the postponed SPS HARQ-ACK is transmitted in the same slot or sub-slot as the HARQ-ACK associated with the DCI, the HARQ-ACK may be transmitted in a dynamic HARQ-ACK resource, and the multiplexing may be performed based on a case where the dynamic HARQ-ACK resource and the PUSCH resource of the CG/DG overlap. In a case where the SPS HARQ-ACK alone is located in the slot or sub-slot, a case of multiplexing with the CG/DG PUSCH is required to be considered.

Hereinafter: a case of multiplexing with the DG/CG PUSCH without repeated transmission; or Case 1 of multiplexing with the DG PUSCH with a single repeated transmission, will be described.

Case 1 includes a case in which DG-PUSCH without repeated transmission and PUCCH for transmitting the postponed SPS HARQ-ACK overlap, includes a case in which PUSCH Repeat Type A with a single repeated transmission and PUCCH for transmitting the postponed SPS HARQ-ACK overlap, and includes a case in which PUSCH Repeat Type B with one or more repeated transmissions and PUCCH for transmitting the postponed SPS HARQ-ACK overlap.

In Option 1, in a case where the overlapping DG/CG-PUSCH (repetition) does not collide with an invalid symbol, the SPS HARQ-ACK may be postponed to a slot or sub-slot where the DG/CG-PUSCH is located, and then may be transmitted by overlapping with the DG/CG-PUSCH.

In Option 1, the SPS HARQ-ACK may be dropped in a case where the overlapping DG/CG-PUSCH (repetition) collides with an invalid symbol. Also, in Option 1, in a case where the overlapping DG/CG-PUSCH (repetition) collides with an invalid symbol, and in a case where the conditions for further postponement are satisfied, the SPS HARQ-ACK transmission may be postponed to the next slot or sub-slot, and in a case where such conditions are not satisfied, the SPS HARQ-ACK may be dropped.

Also, in Option 1, in a case where the overlapping DG/CG-PUSCH (repetition) collides with an invalid symbol, the TDD configuration of the PUCCH resource for the postponed SPS HARQ-ACK before multiplexing may be checked. In a case where the PUCCH resource for the postponed SPS HARQ-ACK before multiplexing does not collide with an invalid symbol, the SPS HARQ-ACK may be transmitted via the PUCCH resource for the postponed SPS HARQ-ACK before multiplexing. In a case where the PUCCH resource for the postponed SPS HARQ-ACK before multiplexing collides with an invalid symbol, the SPS HARQ-ACK may be dropped, and in a case where the conditions for further postponement are satisfied, the SPS HARQ-ACK transmission may be postponed to the next slot or sub-slot, and in a case where the conditions are not satisfied, the SPS HARQ-ACK may be dropped.

In Option 2, in a case where the PUCCH resource for the postponed SPS HARQ-ACK does not collide with an invalid symbol, the terminal 20 may perform the operations illustrated in 1) or 2) below.
1) In a case where the DG/CG-PUCCH (repetition) collides with an invalid symbol, multiplexing with the DG/CG-PUSCH is not required to be performed, and the postponed SPS HARQ-ACK may be transmitted in the slot or sub-slot where the DG/CG-PUSCH is located.
2) In a case where the DG/CG-PUCCH does not collide with an invalid symbol, the postponed SPS HARQ-ACK may be multiplexed to be transmitted by overlapping with the DG/CG-PUSCH (repetition).

In Option 2, in a case where the PUCCH resource for the postponed SPS HARQ-ACK collides with an invalid symbol, the terminal 20 may drop the SPS HARQ-ACK and, in a case where the conditions for further postponement are satisfied, the transmission of the SPS HARQ-ACK may be postponed to the next slot or subslot, and in a case where such conditions are not satisfied, the SPS HARQ-ACK may be dropped.

Hereinafter, Case 2 of multiplexing with multiple DG/CG PUSCHs with repeated transmissions, will be described.

Case 2 includes a case in which the postponed SPS HARQ-ACK overlaps with multiple repeated transmissions of PUSCH repetition type A.

In Option 1, in a case where at least one overlapping DG/CG-PUSCH repetition does not collide with an invalid symbol, the SPS HARQ-ACK may be postponed to a slot or sub-slot where the DG/CG-PUSCH is located, and then may be transmitted by overlapping with the DG/CG-PUSCH repetition.

In Option 1, the SPS HARQ-ACK may be dropped in a case where the overlapping DG/CG-PUSCH repetition collides with an invalid symbol. Also, in Option 1, in a case where the overlapping DG/CG-PUSCH repetition collides with an invalid symbol, and in a case where the conditions for further postponement are satisfied, the SPS HARQ-ACK transmission may be postponed to the next slot or sub-slot, and in a case where the conditions are not satisfied, the SPS HARQ-ACK may be dropped.

In addition, in Option 1, the TDD configuration of the PUCCH resource for the postponed SPS HARQ-ACK before multiplexing, may be checked in a case where the overlapping DG/CG-PUSCH repetition collides with an invalid symbol. In a case where the PUCCH resource for the postponed SPS HARQ-ACK before multiplexing does not collide with an invalid symbol, the SPS HARQ-ACK may be transmitted via the PUCCH resource for the postponed SPS HARQ-ACK before multiplexing. In a case where the PUCCH resource for the postponed SPS HARQ-ACK before multiplexing collides with an invalid symbol, the SPS HARQ-ACK may be dropped, and in a case where the conditions for further postponement are satisfied, the SPS HARQ-ACK transmission may be postponed to the next slot or sub-slot, and in a case where the conditions are not satisfied, the SPS HARQ-ACK may be dropped.

In Option 2, in a case where the PUCCH resource for the postponed SPS HARQ-ACK does not collide with an invalid symbol, the terminal 20 may perform the operations illustrated in 1) or 2) below.
1) In a case where all DG/CG-PUSCH repetitions collide with an invalid symbol, multiplexing with DG/CG-PUSCH is not required to be performed, and the postponed SPS HARQ-ACK may be transmitted in a slot or sub-slot where DG/CG-PUSCH is located.
2) In a case where at least one DG/CG-PUSCH repetition does not collide with an invalid symbol, the postponed SPS HARQ-ACK may be multiplexed to be transmitted by overlapping with the DG/CG-PUSCH repetition.

In Option 2, in a case where the PUCCH resource for the postponed SPS HARQ-ACK collides with an invalid symbol, the terminal 20 may drop the SPS HARQ-ACK and, in a case where the conditions for further postponement are satisfied, the transmission of the SPS HARQ-ACK may be postponed to the next slot or subslot, and in a case where such conditions are not satisfied, the SPS HARQ-ACK may be dropped.

### Application Examples

In the embodiments described above, any method may be used for evaluating and determining the PUCCH resource, based on the transmission direction of the symbol.

Which of Option 1 or Option 2 described above is to be applied may be determined based on multiplexing types. For example, different options may be applied between: a case of multiplexing with dynamic HARQ-ACK; a case of multiplexing with PUCCH of SP-CSI/P-CSI; and a case of multiplexing with PUSCH Repetition Type B. In addition, which of Option 1 and Option 2 described above is to be applied may be determined based on upper layer parameters, may be determined based on UE capabilities reported by the terminal 20, may be predefined in the specification, or may be determined based on configurations of upper layer parameters and UE capabilities.

(UE Capability Information)

In order to avoid dropping of the SPS HARQ-ACK due to collision of at least one “DL or F symbol” with the PUCCH resource in a case of the TDD scheme, UE capability information indicating whether the terminal 20 supports the functions illustrated in 1) and 2) below may be used. The UE capability information is indicated from the terminal 20 to the base station 10, and the base station 10 may, for example, indicate, to the terminal 20, the applicable resource area pattern based on the UE capability information.
1) UE capability information indicating whether the HARQ-ACK postponement is supported in the TDD method.
2) UE Capability Information indicating whether the function of configuring the applicable resource area pattern for the HARQ-ACK postponement is supported.

(Device Configuration)

Next, a functional configuration example of the base station 10 and the terminal 20 for performing the processes and operations described above will be described. The base station 10 and the terminal 20 include functions for executing the embodiments described above. However, each of the base stations 10 and the terminal 20 may comprise only the proposed function of any of the embodiments.

<Base Station 10>

FIG. 14 is a diagram illustrating an example of a functional configuration of the base station 10. As illustrated in FIG. 14, the base station 10 includes a transmitter 110, a receiver 120, a setter 130, and a controller 140. The functional configuration illustrated in FIG. 14 is only one example. If the operation according to the embodiments of the present invention can be performed, the function category and the name of the function unit may be anything. The transmitter 110 and the receiver 120 may be referred to as a communication unit.

The transmitter 110 includes a function for generating a signal to be transmitted to the terminal 20 side and transmitting the signal wirelessly. The receiver 120 includes a function for receiving various signals transmitted from the terminal 20 and acquiring, for example, information of a higher layer from the received signals. The transmitter 110 has a function to transmit NR-PSS, NR-SSS, NR-PBCH, DL/UL control signals, DL data, and the like to the terminal 20. The transmitter 110 transmits the configuration information described in options 1 to 2.

The setter 130 stores the preset configuration information and various configuration information to be transmitted to the terminal 20 in the storage device and reads the preset configuration information from the storage device if necessary. For example, the controller 140 allocates resources and controls the entire base station 10. A function unit related to signal transmission in the controller 140 may be included in the transmitter 110, and a function unit related to signal reception in the controller 140 may be included in the receiver 120. The transmitter 110 and the receiver 120 may be called a transmitter and a receiver, respectively.

<Terminal 20>

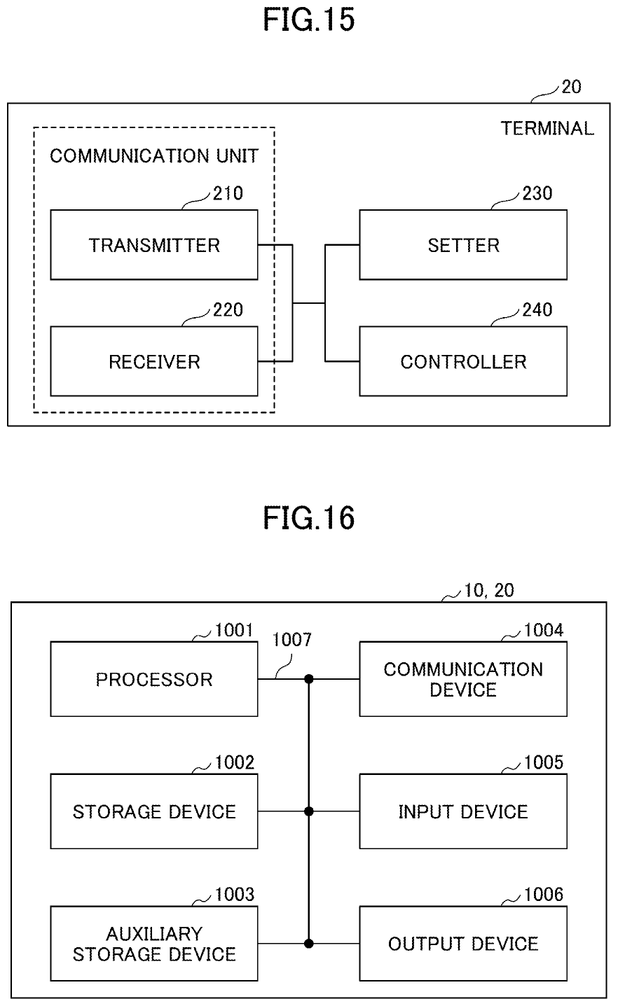

FIG. 15 is a diagram illustrating an example of a functional configuration of the terminal 20. As illustrated in FIG. 15, the terminal includes a transmitter 210, a receiver 220, a setter 230, and a controller 240. The functional configuration illustrated in FIG. 15 is only one example. If the operation according to the embodiments of the present invention can be performed, the function category and the name of the function unit may be anything. The transmitter 210 and the receiver 220 may be called a communication unit.

The transmitter 210 creates a transmission signal from the transmission data and wirelessly transmits the transmission signal. The receiver 220 receives various signals wirelessly and acquires signals from higher layers from the received signal of the physical layer. The transmitter 210 transmits the HARQ-ACK, and the receiver 220 receives the configuration information described in options 1 to 2.

The setter 230 stores various configuration information received from the base station 10 by the receiver 220 in the storage device and reads it from the storage device as necessary. The setter 230 also stores the preset configuration information. The controller 240 controls the entire terminal 20. A function unit related to signal transmission in the controller 240 may be included in the transmitter 210, and a function unit related to signal reception in the controller 240 may be included in the receiver 220. The transmitter 210 and the receiver 220 may be called a transmitter and a receiver, respectively.

### Summary of Embodiments

As described above, according to an embodiment of the present invention, a terminal is provided. The terminal includes: a receiver configured to receive data according to SPS (Semi Persistent Scheduling); a controller configured to postpone transmission of a first channel for transmitting feedback information with respect to the data until a valid uplink resource is determined, and determine a resource for transmitting the first channel in a case where the postponed first channel is overlapped in a time domain with a second channel, the second channel being another uplink channel; and a transmitter configured to transmit the feedback information to a base station in the determined resource.

With the above configuration, the terminal is enabled to resolve overlapping of the resource for transmitting the HARQ-ACK corresponding to the SPS with other UL channels and an invalid resource, to determine the appropriate resource for transmitting the HARQ-ACK, and to transmit the HARQ-ACK to the base station 10. That is, the terminal that has received data is enabled to appropriately transmit feedback information to the base station.

The controller may perform a first process of multiplexing the first channel and the second channel and a second process of checking whether the first channel and the second channel are located in a valid uplink resource. The configuration allows the terminal 20 to resolve the overlap of resources sending the HARQ-ACK corresponding to the SPS with other UL channels and with an invalid resource and to determine the appropriate resources for sending the HARQ-ACK.

The controller may be enabled to configure which of the first process or the second process is to be performed first. The configuration allows the terminal 20 to resolve the overlap of resources sending the HARQ-ACK corresponding to the SPS with other UL channels and with an invalid resource and determine the appropriate resources for sending the HARQ-ACK.

In a case where the controller is unable to determine a valid uplink resource for transmitting the first channel after performing the first process and the second process, the controller may further postpone transmission of the first channel. The configuration allows the terminal 20 to resolve the overlap of resources sending the HARQ-ACK corresponding to the SPS with other UL channels and with an invalid resource and determine the appropriate resources for sending the HARQ-ACK.

The controller may further postpone transmission of the first channel in a case where the controller is unable to determine a valid uplink resource for transmitting the first channel after performing the first process and the second process and where a maximum offset value from data to feedback information transmission is not exceeded. The configuration allows the terminal 20 to resolve the overlap of resources sending the HARQ-ACK corresponding to the SPS with other UL channels and with an invalid resource and determine the appropriate resources for sending the HARQ-ACK.

In addition, according to an embodiment of the present invention, there is provided a communication method performed by a terminal. The communication method includes: receiving data according to SPS (Semi persistent scheduling); postponing transmission of a first channel for transmitting feedback information with respect to the data until a valid uplink resource is determined; and determining a resource for transmitting the first channel in a case where the postponed first channel is overlapped in a time domain with a second channel, the second channel being another uplink channel; and transmitting the feedback information to a base station in the determined resource.

With the above configuration, the terminal can resolve the resource sending the HARQ-ACK corresponding to the SPS overlapping with other UL channels and an invalid resource, determine the appropriate resource for sending the HARQ-ACK, and transmit the HARQ-ACK to the base station 10. That is, the terminal that has received data can appropriately transmit feedback information to the base station.

(Hardware Configuration)

Block diagrams (FIGS. 14 and 15) used in the description of the above embodiments illustrate blocks of functional units. These functional blocks (components) are implemented by any combination of hardware and/or software. In addition, an implementation method of each functional block is not particularly limited. That is, each functional block may be implemented using a single device that is physically or logically combined, or two or more devices that are physically or logically separated may be directly or indirectly connected (e.g., using wired, wireless, etc.) and implemented using these multiple devices. The functional block may be implemented by combining software with the device or devices.

Functions include, but are not limited to, judgment, determination, determination, calculation, calculation, processing, derivation, research, search, verification, reception, transmission, output, access, resolution, selection, selection, establishment, comparison, assumption, expectation, and deeming; broadcasting, notifying, communicating, forwarding, configuring, reconfiguring, allocating, mapping, and assigning. For example, a functional block (component) that functions to perform transmission is called a transmission unit or a transmitter. In either case, as described above, the realization method is not particularly limited.

For example, the base station 10, the terminal 20, etc., according to an embodiment of the present disclosure may function as a computer for processing the radio communication method of the present disclosure. FIG. 16 is a diagram illustrating an example of the hardware configuration of the base station 10 and the terminal 20 according to an embodiment of the present disclosure. The base station 10 and the terminal 20 described above may be physically configured as a computer device including a processor 1001, a storage device 1002, an auxiliary storage device 1003, a communication device 1004, an input device 1005, an output device 1006, a bus 1007, and the like.

In the following description, the term “apparatus” can be read as circuits, devices, units, etc. The hardware configuration of the base station and terminal 20 may be configured to include one or more of the devices illustrated in the figures or may be configured without some of the devices.

The functions in the base station 10 and the terminal 20 are realized by the processor 1001 performing operations by reading predetermined software (programs) on hardware such as the processor 1001 and the storage device 1002, and controlling communication by the communication device 1004 and controlling at least one of reading and writing of data in the storage device 1002 and the auxiliary storage device 1003.

The processor 1001 operates, for example, an operating system to control the entire computer. The processor 1001 may be comprised of a central processing unit (CPU) including an interface with peripheral devices, a controller, an arithmetic unit, a register, and the like. For example, the above-described controller 140, controller 240, and the like may be implemented by the processor 1001.

The processor 1001 reads out a program (program code), software module, data, or the like from at least one of the auxiliary storage device 1003 and the communication device 1004 to the storage device 1002 and performs various processing in accordance with the above. As a program, a program that causes a computer to execute at least a part of the operation described in the above-described embodiment is used. For example, the controller 140 of the base station 10 illustrated in FIG. 14 may be stored in the storage device 1002 and implemented by a control program operating in the processor 1001. For example, the controller 240 of the terminal 20 illustrated in FIG. 15 may be stored in the storage device 1002 and implemented by a control program operating in the processor 1001. Although the foregoing processes have been described and executed by one processor 1001, they may be executed simultaneously or sequentially by two or more processors 1001. Processor 1001 may be implemented by one or more chips. The program may be transmitted from the network via a telecommunication line.

The storage device 1002 is a computer-readable recording medium and may be comprised of at least one of, for example, ROM (Read Only Memory), EPROM (Erasable Programmable ROM), EEPROM (Electrically Erasable Programmable ROM), RAM (Random Access Memory), and the like. The storage device 1002 may be referred to as a register, cache, main memory (main memory), or the like. The storage device 1002 can store programs (program codes), software modules, etc., executable to implement a communication method according to an embodiment of the present disclosure.

The auxiliary storage device 1003 is a computer-readable recording medium and may comprise at least one of an optical disk, such as a CD-ROM (Compact Disc ROM), a hard disk drive, a flexible disk, a magneto-optical disk (e.g., a compact disk, a digital versatile disk, a Blu-ray disk), a smart card, a flash memory (e.g., a card, a stick, a key drive), a floppy disk, a magnetic strip, and the like. The storage medium described above may be, for example, a database, a server, or other suitable medium that includes at least one of a storage device 1002 and an auxiliary storage device 1003.

The communication device 1004 is a hardware (transmitting/receiving device) for performing communication between computers via at least one of a wired network and a wireless network, and is also referred to as a network device, a network controller, a network card, a communication module, or the like. The communication device 1004 may comprise a high frequency switch, duplexer, filter, frequency synthesizer, or the like, for example, to implement at least one of a frequency division duplex (FDD) and a time division duplex (TDD). For example, the transmitting/receiving antenna, the amplifier unit, the transceiving unit, the transmission line interface, and the like may be implemented by the communication device 1004. Transmitters and receptacles may be physically or logically isolated implementations of the transmitters and receivers.

The input device 1005 is an input device (e.g., a keyboard, mouse, microphone, switch, button, sensor, etc.) that accepts external input. Output device 1006 is an output device (e.g., a display, speaker, LED lamp, etc.) that implements an external output. The input device 1005 and the output device 1006 may be integrated into a single device (for example, a touch panel).

Each device, such as a processor 1001 and a storage device 1002, is connected by the bus 1007 for communicating information. The bus 1007 may be constructed using a single bus or may be constructed using different buses between devices.

The base station 10 and terminal 20 may also include hardware such as a microprocessor, a digital signal processor (DSP), an ASIC (Application Specific Integrated Circuit), a PLD (Programmable Logic Device), an FPGA (Field Programmable Gate Array), and some or all of the functional blocks may be realized by the hardware. For example, processor 1001 may be implemented using at least one of the hardware.

### Supplement to Embodiments

Thus, although embodiments of the present invention have been described, the disclosed invention is not limited to such embodiments, and various modifications, modifications, alternatives, substitutions, etc. will be understood by those skilled in the art. Specific numerical examples have been used to facilitate understanding of the invention, but unless otherwise indicated, they are merely examples and any appropriate values may be used. Classification of items in the above description is not essential to the present invention, and the items described in two or more items may be used in combination as needed, or the items described in one item may be applied to the items described in another item (unless there is a conflict). The functional or processing unit boundaries in the functional block diagram do not necessarily correspond to the physical part boundaries. The operation of the plurality of functions may be performed physically by one component, or the operation of one function may be performed physically by the plurality of components. As for the processing procedure described in the embodiment, the order of the processing may be changed if there is no conflict. For convenience of process description, the base station 10 and terminal 20 have been described using a functional block diagram, but such devices may be implemented in hardware, software, or a combination thereof. Software operated by a processor of the base station in accordance with embodiments of the present invention and software operated by a processor of the terminal 20 in accordance with embodiments of the present invention may be stored in random access memory (RAM), flash memory, read only memory (ROM), EPROM, EEPROM, register, hard disk (HDD), removable disk, CD-ROM, database, server, or any other suitable storage medium.

Information may also be communicated in other ways, as well as in the manner/embodiments described in this disclosure. For example, indication of information may be performed by physical layer signaling (e.g., DCI (Downlink Control Information), UCI (Uplink Control Information), upper layer signaling (e.g., RRC (Radio Resource Control) signaling, MAC (Medium Access Control) signaling, MIB (Master Information Block), SIB (System Information Block)), other signals, or a combination thereof. The RRC signaling may also be referred to as an RRC message, and may be, for example, an RRC Connection Setup message, an RRC Connection Reconfiguration message, or the like.

Each aspect/embodiment described in this disclosure is as follows: LTE (Long Term Evolution), LTE-A (LTE-Advanced), SUPER 3G, IMT-Advanced, 4G (4th generation mobile communication system), 5G (5th generation mobile communication system), FRA (Future Radio Access), NR (new Radio), W-CDMA (registered trademark), GSM (registered trademark), CDMA2000 UMB (Ultra Mobile Broadband), IEEE 802.11 (Wi-Fi), IEEE 802.16 (WiMAX), IEEE 802.20 (Ultra-WideBand), Bluetooth (Registered), and may be applied to at least one of the systems utilizing other appropriate systems and the next generation systems extended thereon. Multiple systems may also be applied in combination (e.g., at least one of LTE and LTE-A combined with 5G, etc.).

The processing procedures, sequences, flowcharts, etc. of each aspect/embodiment described herein may be reordered if there is no conflict. For example, the methods described in the present disclosure are presented using exemplary sequences to present elements of the various steps and are not limited to the particular order presented.

The specific operations described herein as performed by the base station 10 may be performed by its upper node in some cases. In a network of one or more network nodes having a base station 10, it will be apparent that various operations performed for communication with terminal 20 may be performed by at least one of the base station 10 and other network nodes other than base station 10 (e.g., but not limited to MME, S-GW, etc.). Although the above illustrates that there is only one other network node other than the base station 10, the other network nodes may be a combination of multiple other network nodes (e.g., MME and S-GW).

The information or signals described in this disclosure can be output from a higher layer (or lower layer) to a lower layer (or higher layer). It may be input and output through multiple network nodes.

Input and output information may be stored in a specific location (e.g., memory) or managed using management tables. Input and output information may be overwritten, updated, or added. The output information may be deleted. The input information or the like may be transmitted to another device.

The determination in this disclosure may be made by a value (0 or 1) expressed in 1 bit, by a true or false value (Boolean: true or false), or by a numerical comparison (e.g., a comparison with a predetermined value).

Software should be broadly interpreted to mean, whether referred to as software, firmware, middleware, microcode, hardware description language, or any other name, instructions, sets of instructions, code, code segments, program code, programs, subprograms, software modules, applications, software applications, software packages, routines, subroutines, objects, executable files, executable threads, procedures, functions, and the like.

Software, instructions, information, and the like may also be transmitted and received via a transmission medium. For example, when software is transmitted from a website, server, or other remote source using at least one of wired technology (such as coaxial cable, fiber optic cable, twisted pair, digital subscriber line (DSL)) and wireless technology (infrared, microwave, etc.), at least one of these wired technology and wireless technology is included within the definition of a transmission medium.

The information, signals and the like described in this disclosure may be represented using any of a variety of different techniques. For example, data, instructions, commands, information, signals, bits, symbols, chips, etc., which may be referred to throughout the above description may be represented by voltages, currents, electromagnetic waves, magnetic fields or magnetic particles, optical fields or photons, or any combination thereof.

The terms described in the present disclosure and those necessary for understanding the present disclosure may be replaced by terms having the same or similar meanings. For example, at least one of the channels and the symbols may be a signal (signaling). The signal may also be a message. The component carrier (CC) may also be referred to as a carrier frequency, cell, frequency carrier, or the like.

As used in this disclosure, the terms “system” and “network” are used interchangeably.

The information, parameters, and the like described in the present disclosure may also be expressed using absolute values, relative values from predetermined values, or they may be expressed using corresponding separate information. For example, the wireless resources may be those indicated by an index.

The name used for the parameters described above is not restrictive in any respect. In addition, the mathematical equations using these parameters may differ from those explicitly disclosed in this disclosure. Since the various channels (e.g., PUCCH, PDCCH, etc.) and information elements can be identified by any suitable name, the various names assigned to these various channels and information elements are not in any way limiting.

In this disclosure, terms such as “base station (BS)”, “wireless base station”, “base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like may be used interchangeably. The base station may also be referred to as a macrocell, a small cell, a femtocell, a picocell, or the like.

The base station can accommodate one or more (e.g., three) cells. If the base station accommodates a plurality of cells, the entire coverage area of the base station can be divided into a plurality of smaller areas, each of which can also provide communications services via a base station subsystem (e.g., a small indoor base station (RRH) or Remote Radio Head). The term “cell” or “sector” refers to part or all of the coverage area of at least one of the base station and base station subsystem that provides communications services at the coverage.

In this disclosure, terms such as “mobile station (MS)”, “user terminal”, “user equipment (UE)”, “terminal”, and the like may be used interchangeably.

The mobile station may be referred to by one of ordinary skill in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable term.

At least one of the base stations and the mobile station may be referred to as a transmitter, receiver, communication device, or the like. At least one of the base station and the mobile station may be a device mounted on the mobile body, a mobile body, or the like. The mobile station may be a vehicle (e.g., a car, an airplane, etc.), an unmanned mobile (e.g., a drone, an automated vehicle, etc.), or a robot (manned or unmanned). At least one of the base station and the mobile station includes a device that does not necessarily move during communication operations. For example, at least one of the base station and the mobile station may be an IoT (Internet of Things) device such as a sensor.

In addition, the base station in the present disclosure may be read by the user terminal. For example, various aspects/embodiments of the present disclosure may be applied for a configuration in which communication between base stations and user terminals is replaced by communication between multiple terminals 20 (e.g., may be referred to as D2D (Device-to-Device), V2X (Vehicle-to-Everything), etc.). In this case, the terminal 20 may have the functions provided by the base station 10 described above. The phrases “uplink” and “downlink” may also be relocated by the phrases corresponding to terminal-to-terminal communication (e.g., “side”). For example, an uplink channel, a downlink channel, or the like may be read as a side channel.

Similarly, the user terminal in the present disclosure may be read as the base station. In this case, the base station may have the functions provided by the user terminal described above.

As used in this disclosure, the term “determining” may encompass a wide variety of operations. “Judgment” includes, for example, judging, calculating, computing, processing, deriving, investigating, looking up (search, inquiry) (e.g., searching in tables, databases, or other data structures), ascertaining, and so forth. “Judgment” and “decision” may also include receiving (e.g., receiving information), transmitting (e.g., sending information), input, output, and accessing (e.g., accessing data in memory) as “judged” and “determined”, and the like. “Judgment” and “decision” may also include “judgment” and “decision” regarding matters such as resolving, selecting, choosing, establishing, comparing, etc., that is, the “judgment” and the “decision” may include deeming some action to be “judgment” and “determination”. “Decision” may be read as “Assuming”, “Expecting”, or “Considering”, etc.

The term “connected” or “coupled” or any variation thereof means any direct or indirect connection or connection between two or more elements and may include the presence of one or more intermediate elements between two elements “connected” or “coupled” with each other. The coupling or connection between the elements may be physical, logical, or a combination of these. For example, “connection” may be read as “access”. As used in the present disclosure, the two elements may be thought of as being “connected” or “coupled” to each other using at least one of the one or more wires, cables, and printed electrical connections and, as a number of non-limiting and non-inclusive examples, electromagnetic energy having wavelengths in the radio frequency region, the microwave region, and the light (both visible and invisible) region.

The reference signal may be abbreviated as RS (Reference Signal) or may be referred to as a pilot, depending on the standards applied.

As used in this disclosure, the expression “based on” does not mean “solely based on” unless otherwise specified. In other words, the expression “based on” means both “solely based on” and “at least based on”.

Any reference to an element using terms such as “first” or “second” as used in the present disclosure does not generally limit the amount or order of those elements. These terms can be used in the present disclosure as a convenient way to distinguish between two or more elements. Thus, references to the first and second elements do not imply that only two elements may be employed or that the first element must in some way precede the second element.

“Means” in the configuration of each of the above devices may be replaced by “parts,” “circuits,” “devices,” etc.

When the terms “include”, “including” and variations thereof are used in the present disclosure, these terms are intended to be comprehensive as well as the term “comprising”. Moreover, the term “or” as used in this disclosure is not intended to be an exclusive-OR.

The wireless frame may consist of one or more frames in the time domain. Each frame or frames in the time domain may be referred to as subframes. The subframe may further comprise one or more slots in the time domain. The subframe may be a fixed length of time (e.g., 1 ms) independent of the numerology.

The numerology may be a communication parameter that is applied to at least one of the transmission and reception of a signal or channel. The numerology may indicate at least one of, for example, SubCarrier Spacing (SCS), bandwidth, symbol length, cyclic prefix length, transmit time interval (TTI), number of symbols per TTI, wireless frame configuration, specific filtering processing performed by the transceiver in the frequency domain, and specific windowing processing performed by the transceiver in the time domain.

The slot may include one or more symbols in the time domain, such as OFDM (Orthogonal Frequency Division Multiplexing) symbols, SC-FDMA (Single Carrier Frequency Division Multiple Access) symbols, and the like. The slot may be in time units based on a numerology.

The slots may include a plurality of minislots. Each minislot may be comprised of one or more symbols in the time domain. The minislot may also be referred to as a subslot. The minislots may consist of fewer symbols than the slots. A PDSCH (or PUSCH) transmitted in time units greater than a minislot may be called a PDSCH (or PUSCH) mapping type A. PDSCH (or PUSCH) transmitted using minislots may be referred to as PDSCH (or PUSCH) mapping type B.

Radio frames, subframes, slots, minislots and symbols all represent time units for transmitting signals. Radio frames, subframes, slots, minislots and symbols, respectively, may be referred to as different names.

For example, one subframe may be referred to as a Transmission Time Interval (TTI), multiple consecutive subframes may be referred to as a TTI, and one slot or one minislot may be referred to as a TTI. That is, at least one of the subframes and the TTI may be a subframe (1 ms) in an existing LTE, a period shorter than 1 ms (e.g., 1-13 symbols), or a period longer than 1 ms. The unit representing the TTI may be referred to as a slot, a minislot, or the like, rather than a subframe.

The TTI refers, for example, to the minimum time unit for scheduling in wireless communication. For example, in an LTE system, a base station schedules each terminal 20 to allocate wireless resources (such as frequency bandwidth, transmit power, etc. that can be used in each terminal 20) in TTI units. The definition of TTI is not limited to this.

The TTI may be a transmission time unit, such as a channel-encoded data packet (transport block), code block, codeword, or the like, or may be a processing unit, such as a scheduling or link adaptation. When a TTI is provided, the time interval (e.g., the number of symbols) during which the transport block, code block, codeword, or the like is actually mapped may be shorter than the TTI.

If one slot or one minislot is referred to as a TTI, one or more TTIs (i.e., one or more slots or one or more minislots) may be the minimum time unit for scheduling. The number of slots (minislots) constituting the minimum time unit of the scheduling may also be controlled.

A TTI having a time length of 1 ms may be referred to as a TTI (usually a TTI in LTE Rel. 8-12), a normal TTI, a long TTI, a normal subframe, a normal subframe, a long subframe, a slot, and the like. A TTI that is typically shorter than a TTI may be referred to as a shortened TTI, a short TTI, a partial TTI (partial or fractional TTI), a shortened subframe, a short subframe, a minislot, a subslot, a slot, or the like.

The long TTI (e.g., usually TTI, subframe, etc.) may be interpreted as a TTI having a time length exceeding 1 ms, and the short TTI (e.g., shortened TTI, etc.) may be interpreted as a TTI having a TTI length less than the TTI length of the long TTI and a TTI length greater than 1 ms.

The resource block (RB) is a time domain and frequency domain resource allocation unit and may include one or more consecutive subcarriers in the frequency domain. The number of subcarriers included in the RB may be the same regardless of the numerology, for example 12. The number of subcarriers included in the RB may be determined on the basis of numerology.

The time domain of the RB may also include one or more symbols, which may be 1 slot, 1 minislot, 1 subframe, or 1 TTI in length. One TTI, one subframe, etc., may each consist of one or more resource blocks.

Note that one or more RBs may be referred to as physical resource blocks (PRBs: physical RBs), sub-carrier groups (SCGs), resource element groups (REGs), PRB pairs, RB pairs, and the like.

The resource block may also consist of one or more resource elements (RE). For example, 1 RE may be a wireless resource area of one sub-carrier and one symbol.

The bandwidth portion (which may also be referred to as a partial bandwidth, etc.) may represent a subset of consecutive common RB (common resource blocks) for a given numerology in a carrier. Here, the common RB may be identified by an index of RB relative to the common reference point of the carrier. A PRB is defined in a BWP and may be numbered within that BWP.

BWP may include BWP for UL (UL BWP) and BWP for DL (DL BWP). One or more BWPs may be configured in one carrier for the terminal 20.

At least one of the configured BWPs may be active, and the terminal 20 may not assume to transmit or receive predetermined signals/channels outside the active BWP. The terms “cell” and “carrier” in this disclosure may be relocated by “BWP.”

Structures such as radio frames, subframes, slots, minislots, and symbols described above are exemplary only. For example, the number of subframes included in a wireless frame, the number of slots per subframe or wireless frame, the number of minislots included in the slot, the number of symbols and RBs included in the slot or minislot, the number of subcarriers included in the RB, the number of symbols in the TTI, the symbol length, the length of the cyclic prefix (CP) length, and the like may vary.

In the present disclosure, where an article is added by translation, for example “a”, “an”, and “the” in the English language, the disclosure may include that the noun following these articles is plural.

In this disclosure, the term “A and B are different” may mean “A and B are different from each other.” Incidentally, the term may mean “A and B are different from C.” Terms such as “separated” or “combined” may be interpreted in the same way as “different”.

The aspects/embodiments described in the present disclosure may be used alone, used in combination, or switched with implementation. Notice of a given information (e.g. “X” notice) may also be given by implication (e.g. “no notice of the given information”), not explicitly.

While the present disclosure has been described in detail above, those skilled in the art will appreciate that the present disclosure is not limited to the embodiments described in the present disclosure. The disclosure may be implemented as modifications and variations without departing from the spirit and scope of the disclosure as defined by the claims. Accordingly, the description of the present disclosure is for illustrative purposes only and is not intended to have any restrictive meaning with respect to the present disclosure.

The present international application claims priority under Japanese Patent Application No. 2020-187613 filed with the Japanese Patent Office on Nov. 10, 2020, and the entire contents of Japanese Patent Application No. 2020-187613 are incorporated herein by reference.

### DESCRIPTION OF REFERENCE CODES

10 Base station
110 Transmitter
120 Receiver
130 Setter
140 Controller
20 Terminal
210 Transmitter
220 Receiver
230 Setter
240 Controller
1001 Processor
1002 Storage device
1003 Auxiliary storage device
1004 Communication device
1005 Input device
1006 Output device

1. A terminal comprising:
a receiver configured to receive data according to SPS (Semi Persistent Scheduling);
a controller configured to
postpone transmission of a first channel for transmitting feedback information with respect to the data until a valid uplink resource is determined, and
determine a resource for transmitting the first channel in a case where the postponed first channel is overlapped in a time domain with a second channel, the second channel being another uplink channel; and
a transmitter configured to transmit the feedback information to a base station in the determined resource.

2. The terminal according to claim 1, wherein
the controller performs
a first process of multiplexing the first channel and the second channel and
a second process of checking whether the first channel and the second channel are located in a valid uplink resource.

3. The terminal according to claim 2, wherein
the controller is enabled to configure which of the first and second processes is to be performed first.

4. The terminal according to claim 3, wherein
the controller further postpones transmission of the first channel in a case where the controller is unable to determine the valid uplink resource for transmitting the first channel after performing the first process and the second process.

5. The terminal according to claim 4, wherein
the controller further postpones transmission of the first channel in the case where the controller is unable to determine the valid uplink resource for transmitting the first channel after performing the first process and the second process, and in a case where a maximum offset value from the data to feedback information transmission is not exceeded.

6. A communication method comprising:
receiving data according to SPS (Semi Persistent Scheduling);
postponing transmission of a first channel for transmitting feedback information with respect to the data until a valid uplink resource is determined;
determining a resource for transmitting the first channel in a case where the postponed first channel is overlapped in a time domain with a second channel, the second channel being another uplink channel; and
transmitting the feedback information to a base station in the determined resource.
